(19) United States
(12) Patent Application Publication
(10) Pub. No.: US 2023/0119037 A1
(43) Pub. Date: Apr. 20, 2023

(54) INFORMATION PROCESSING APPARATUS, INFORMATION PROCESSING METHOD, AND NON-TRANSITORY STORAGE MEDIUM

(71) Applicant: TOYOTA JIDOSHA KABUSHIKI KAISHA, Toyota-shi (JP)

(72) Inventors: Osamu NAGASAKA, Toyota-shi (JP); Norihiko OSHIO, Nagoya-shi (JP); Kosuke SAKAKIBARA, Toyota-shi (JP); Naoya OKA, Nagakute-shi (JP)

(73) Assignee: TOYOTA JIDOSHA KABUSHIKI KAISHA, Toyota-shi (JP)

(21) Appl. No.: 17/935,243

(22) Filed: Sep. 26, 2022

(30) Foreign Application Priority Data
Oct. 20, 2021 (JP) 2021-171841

(51) Int. Cl. G06Q 40/08

(52) U.S. Cl. CPC G06Q 40/08

(57) ABSTRACT

The present disclosure is for calculating an appropriate insurance premium for a vehicle. An information processing apparatus of the present disclosure determines whether a sticker displaying that an upgrade is performed on an ability of a vehicle in an ex-post manner is attached to a first vehicle. The information processing apparatus identifies contents of the upgrade in a case where the sticker is attached to the first vehicle. The information processing apparatus calculates an insurance premium for the first vehicle by taking into account the contents of the upgrade, in a case where the ability that is upgraded is related to safety.

### CROSS-REFERENCE TO THE RELATED APPLICATION

This application claims the benefit of Japanese Patent Application No. 2021-171841, filed on Oct. 20, 2021, which is hereby incorporated by reference herein in its entirety.

### BACKGROUND

### Technical Field

The present disclosure relates to vehicle insurance.

### Description of the Related Art

It is known that an insurance premium for a vehicle changes depending on a use state and the like of the vehicle. In this regard, Patent Literature 1 discloses a system that calculates an appropriate vehicle insurance premium by taking into account a maintenance/management state of a vehicle.

[Patent Literature 1] Japanese Patent Laid-Open No. 2002-259708

### SUMMARY

One or more aspects of the present disclosure are directed to calculate an appropriate insurance premium for a vehicle.

A first aspect of the present disclosure may be an information processing apparatus comprising a controller including at least one processor configured to determine whether a sticker displaying that an upgrade is performed on an ability of a vehicle in an ex-post manner is attached to a first vehicle, identify contents of the upgrade in a case where the sticker is attached to the first vehicle, and calculate an insurance premium for the first vehicle by taking into account the contents of the upgrade, in a case where the ability that is upgraded is related to safety.

A second aspect of the present disclosure may be an information processing method including: determining whether a sticker displaying that an upgrade is performed on an ability of a vehicle in an ex-post manner is attached to a first vehicle; identifying contents of the upgrade in a case where the sticker is attached to the first vehicle; and calculating an insurance premium for the first vehicle by taking into account the contents of the upgrade, in a case where the ability that is upgraded is related to safety.

Another aspect of the present disclosure may be a non-transitory computer-readable storage medium storing a program for causing a computer to perform the information processing method described above.

According to the present disclosure, an appropriate insurance premium for a vehicle can be calculated.

### BRIEF DESCRIPTION OF THE DRAWINGS

FIG. 1 is a diagram for describing an outline of an insurance premium calculation system;

FIG. 2 is a diagram illustrating an example of a sticker to be attached to a vehicle body;

FIG. 3 is a diagram for describing a location where the sticker is to be attached;

FIG. 4 is a diagram illustrating components of a user terminal 100;

FIG. 5 is a diagram illustrating components of a calculation server 200;

FIG. 6 is an example of user data that is stored in the calculation server;

FIG. 7 is a diagram illustrating components of a vehicle management server 300;

FIG. 8 is an example of maintenance history data that is stored in the vehicle management server;

FIG. 9 is a sequence diagram illustrating processes that are performed by each component of the system;

FIG. 10A is an example of a screen for inputting information about a target vehicle;

FIG. 10B is an example of the screen for inputting information about the target vehicle;

FIG. 11 is an example of a screen for notifying of an attachment location of the sticker;

FIG. 12 is a flowchart of processes that are performed in step S17;

FIG. 13 is an example of a table defining an amount of discount on an insurance premium;

FIG. 14 is an example of an upgrade certificate according to a second embodiment;

FIG. 15 is a sequence diagram illustrating processes that are performed by each component in the second embodiment;

FIG. 16 is an example of a screen for notifying of an attachment location of the upgrade certificate; and

FIG. 17 is an example of the sticker according to a third embodiment.

### DESCRIPTION OF THE EMBODIMENTS

There are techniques for enhancing quality, abilities and the like of a vehicle in an ex-post manner. For example, fabric seats can be changed to leather ones, or a steering wheel can be changed to one with a built-in heater. Furthermore, by updating software of an in-vehicle computer, abilities (abilities related to safety, traveling support abilities, and the like) not installed at a time of sale of a new vehicle may be added.

In the present disclosure, enhancing the ability or the quality of a vehicle through addition of a vehicle part, replacement (update) of a vehicle part, update of software, or the like will be referred to as “upgrade (of a vehicle)”.

Safety of a vehicle is sometimes improved by upgrading the vehicle. For example, an ability for detecting pedestrians, bicycles and the like, an ability for reducing collision damage, and the like may be added (or enhanced) by updating software of an electronic control unit (ECU). Furthermore, abilities for supporting traveling (such as an adaptive cruise control ability, a lane keeping support ability, and the like) may be added. Adding a traveling support ability may reduce fatigue of a driver, and may as a result improve safety.

It is known that an insurance premium of vehicle insurance can be variable depending on safety performance of a vehicle. For example, an insurance premium for bodily injury may be reduced for a vehicle that is capable of detecting pedestrians and bicycles with high accuracy than for a vehicle that is incapable of doing so.

Accordingly, when making an estimate on vehicle insurance, the insurance premium is desirably calculated taking into account the safety performance of the vehicle. However, the insurance premium may not be accurately calculated in a case where an ability related to safety is added in an ex-post manner. For example, even when the ECU is updated in an ex-post manner and various abilities related to safety are added, it is difficult for a user of the vehicle to accurately declare what abilities are added. That is, there is a problem that it is difficult to determine an appropriate insurance premium based solely on declaration by the user.

An information processing apparatus according to the present disclosure solves such a problem.

An information processing apparatus according to a first mode of the present disclosure may include a controller configured to determine whether a sticker displaying that an upgrade is performed on an ability of a vehicle in an ex-post manner is attached to a first vehicle, identify contents of the upgrade in a case where the sticker is attached to the first vehicle, and calculate an insurance premium for the first vehicle by taking into account the contents of the upgrade, in a case where the ability that is upgraded is related to safety.

The sticker in the present disclosure may be a label displaying that a quality or an ability of a vehicle is upgraded in an ex-post manner. The sticker may indicate that a vehicle part is replaced with a part with a higher quality or a more enhanced ability, or may indicate that a predetermined vehicle part (for enhancing the ability of the vehicle) is added in an ex-post manner.

For example, the sticker may be attached at a position of a vehicle body (typically, a center pillar). For example, one sticker is attached to one vehicle. That is, a vehicle to which the sticker is attached may be a vehicle that is upgraded in some way in an ex-post manner. Additionally, the sticker may be a laminated piece of paper, a metal plate or the like.

The information processing apparatus may determine whether the sticker is attached to the first vehicle. The determination may be performed based on contents of input from a user, or based on an image obtained by capturing the first vehicle (for example, a part of the vehicle body), for example.

In the case where the sticker is attached to the first vehicle, the controller may determine whether the ability that is upgraded is related to safety. An ability related to safety may be an ability for sensing pedestrians and bicycles, or an ability for preventing an accident, for example.

The insurance premium may thus be calculated by taking into account whether an ability related to safety is added in an ex-post manner.

Additionally, in the case where the contents of an upgrade may be identified from an external appearance of the sticker, the contents of the upgrade may be identified based on an image obtained by capturing the sticker. Furthermore, in the case where the contents of the upgrade may not be identified from the external appearance of the sticker, a process may be further performed to identify the contents of the upgrade. For example, the controller may make an inquiry to a database storing a maintenance history of the vehicle, or may acquire detailed information about the upgrade through a user by making the user refer to a maintenance record of the vehicle.

Hereinafter, specific embodiments of the present disclosure will be described with reference to the drawings. Hardware configurations, module configurations, functional configurations and the like described in each embodiment are not intended to limit the technical scope of the present disclosure thereto unless stated otherwise.

### First Embodiment

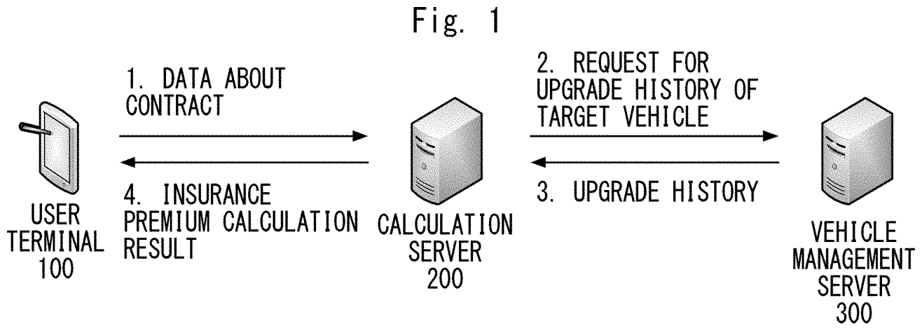

An outline of an insurance premium calculation system according to a first embodiment will be described with reference to FIG. 1. The insurance premium calculation system according to the present embodiment includes a user terminal 100 associated with a user of a vehicle, a calculation server 200 that calculates an insurance premium, and a vehicle management server 300 that manages a maintenance record of the vehicle.

The user terminal 100 is an information processing apparatus that is used by a user associated with a vehicle. A user associated with a vehicle may be an owner of the vehicle, for example. The user terminal 100 may be a terminal that is owned by an end user (for example, the owner of the vehicle), or may be a terminal installed at a sales office of a vehicle manufacturer, an insurance agency or the like.

The calculation server 200 is an apparatus that calculates online an insurance premium of vehicle insurance for a given vehicle, based on information acquired from the user terminal 100. The calculation server 200 collects general information including a model and a model year of a vehicle, age of a driver and an annual mileage, an upgrade history of the vehicle, and the like, and calculates the insurance premium based on these pieces of information.

The vehicle management server 300 is a server apparatus that stores, in a database, a history of maintenance work and the like performed on a vehicle (hereinafter “history information”). The history information includes a history of repairs, a history of upgrades, a history of replacement of consumables, and the like, for example. Of these, the history of upgrades will be referred to as an upgrade history.

The vehicle management server 300 provides the upgrade history about a target vehicle, in response to a request received from the calculation server 200.

Here, the information to be collected by the calculation server 200 will be described.

The calculation server 200 collects, through the user terminal 100, general information such as a model and a model year of a vehicle, age of a driver and an annual mileage. These pieces of information can be relatively easily acquired.

On the other hand, information such as “whether an upgraded vehicle part is mounted on the target vehicle” or “which of a plurality of vehicle parts is upgraded to which grade” is often not accurately grasped by the user. That is, it is difficult for the calculation server 200 to grasp “whether an ability related to safety is added (or updated) in an ex-post manner”.

Accordingly, in the present embodiment, the calculation server 200 first interacts with the user to determine presence/absence of upgrade, and then communicates with the vehicle management server 300 to collect detailed information about the upgrade. The calculation server 200 can thus grasp accurate information about abilities (abilities related to safety) of the target vehicle.

In the present embodiment, the calculation server 200 determines whether an upgrade is performed for the target vehicle, by making the user check a sticker that is attached to the target vehicle.

The sticker in the present disclosure will be described. The sticker in the present disclosure is a label that is attached to a vehicle to certify that the vehicle is upgraded in an ex-post manner. The upgrade may be performed by replacing a predetermined vehicle part, or by adding a vehicle part to enhance an ability of the vehicle.

Target vehicle parts include an electronic control unit (ECU), an in-vehicle computer, a communication device, an infotainment terminal, an air conditioner, a seat, a steering wheel, a door, a sun roof, a mirror, and other electric components, for example.

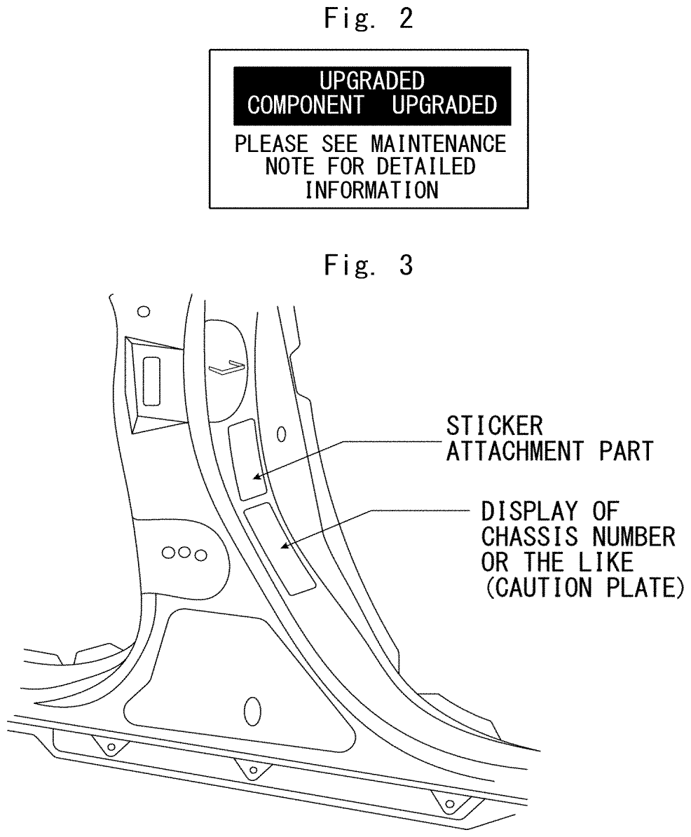

FIG. 2 is a diagram illustrating an example of the sticker. For example, text indicating that the target vehicle is upgraded in an ex-post manner, or that a vehicle part related to upgrade is mounted is written on the sticker. The text to be written on the sticker is not particularly limited as long as it can be determined that the vehicle is upgraded in some way.

The sticker is attached to a predetermined part of the vehicle. FIG. 3 is a diagram for describing a location where the sticker is to be attached. FIG. 3 is a diagram illustrating a vehicle body frame of the vehicle as seen from a front right side. A lower side in the drawing is a side sill, and a center in the drawing is a center pillar (also referred to as a B pillar).

In the present example, the sticker is attached in a predetermined region disposed on the center pillar. An attachment part may be near a caution plate describing a chassis number or the like. By disposing the sticker at such a part, presence/absence of an upgrade can be easily checked by opening a door.

The calculation server 200 determines whether the sticker is attached or not, based on an image obtained by capturing the target vehicle (in the present example, the center pillar). Furthermore, in the case where the sticker is attached to the target vehicle, the calculation server 200 makes an inquiry to the vehicle management server 300, and acquires the upgrade history of the target vehicle. The abilities that the target vehicle currently includes can thus be accurately grasped.

The user terminal 100 will be described in detail.

The user terminal 100 is a computer that is used by a user associated with a vehicle. The user may access the calculation server 200 via the user terminal 100, and may request calculation of the insurance premium for a given vehicle. The user terminal 100 is a personal computer, a smartphone, a mobile phone, a tablet computer, a personal digital assistant or the like, for example.

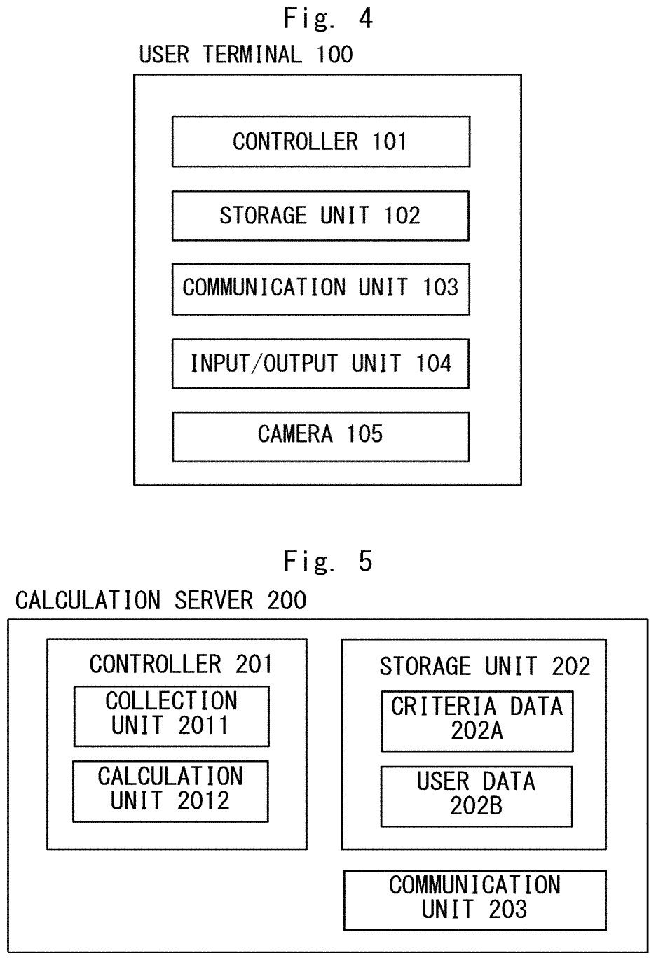

FIG. 4 is a diagram illustrating a system configuration of the user terminal 100.

The user terminal 100 includes a controller 101, a storage unit 102, a communication unit 103, an input/output unit 104, and a camera 105.

The controller 101 is an arithmetic device in charge of control that is performed by the user terminal 100. The controller 101 may be implemented by an arithmetic processing device such as a central processing unit (CPU).

The controller 101 implements a function of accessing the calculation server 200, and interacting with the calculation server 200. This function may be implemented by a web browser running on the user terminal 100, or by dedicated application software.

In the present embodiment, the controller 101 is capable of executing application software for performing interaction with the calculation server 200.

The storage unit 102 includes a main memory and an auxiliary memory. The main memory is a memory where programs to be executed by the controller 101, and data to be used by the control programs are developed. The auxiliary memory is a device where the programs to be executed by the controller 101, and the data to be used by the control programs are stored. Programs to be executed by the controller 101 may be packaged as applications and be stored in the auxiliary memory. Furthermore, an operating system for executing the applications may also be stored. Processes described below are performed by the programs stored in the auxiliary memory being loaded into the main memory and executed by the controller 101.

The main memory may include a random access memory (RAM) and a read only memory (ROM). Furthermore, the auxiliary memory may include an erasable programmable ROM (EPROM) and a hard disk drive (HDD). The auxiliary memory may further include a removable medium, or in other words, a removable recording medium.

The communication unit 103 is a wireless communication interface for connecting the user terminal 100 to a network. The communication unit 103 is capable of communicating with the calculation server 200 via a wireless LAN or a mobile communication service such as 3G, LTE or 5G, for example.

The input/output unit 104 is a unit that receives an input operation performed by a user, and that presents information to the user, and is, in the present embodiment, one touch panel display, or in other words, a liquid crystal display and control means thereof, or a touch panel and control means thereof.

The camera 105 is an optical unit including an image sensor for acquiring images.

Next, the calculation server 200 will be described.

FIG. 5 is a diagram illustrating in detail components of the calculation server 200 included in the insurance premium calculation system according to the present embodiment.

The calculation server 200 is a server apparatus that calculates a vehicle insurance premium for a vehicle based on information collected from the user terminal 100. The calculation server 200 holds data (criteria data) as criteria for calculating the insurance premium, and calculates the insurance premium by checking the information collected from the user terminal 100 against the criteria data.

Furthermore, as described above, the calculation server 200 performs a process of identifying contents of an upgrade, and uses the result in combination to calculate the insurance premium. Specific processes will be described later.

The calculation server 200 may be a computer. That is, the calculation server 200 may be a computer that includes processors such as a CPU and a GPU, main memories such as a RAM and a ROM, and auxiliary memories such as an EPROM, a hard disk drive and a removable medium. The auxiliary memory stores an operating system (OS), various programs, various tables and the like, and a function matching a predetermined object as described below may be implemented by a program stored in the auxiliary memory being loaded in a work area of the main memory and being executed and each structural unit or the like being controlled through execution of the program. However, one or some or all of functions may alternatively be implemented by a hardware circuit such as an ASIC or an FPGA.

In the present embodiment, the calculation server 200 may be capable of implementing a software server for performing interaction with the user terminal 100. In this case, the user terminal 100 may input/output information by accessing a service using a browser or dedicated application software, for example.

The calculation server 200 includes a controller 201, a storage unit 202, and a communication unit 203.

The controller 201 is an arithmetic device in charge of control that is performed by the calculation server 200. The controller 201 can be implemented by an arithmetic processing device such as a CPU.

The controller 201 includes two functional modules, namely, a collection unit 2011 and a calculation unit 2012. Each functional module may be implemented by execution of a stored program by the CPU.

The collection unit 2011 collects data for calculating the insurance premium, by interacting with the user terminal 100. The collection unit 2011 acquires the following two types of data from the user terminal 100.

### (1) General Information About Vehicle and Driver

For example, general information that is required at the time of signing of an insurance contract, such as the model and the model year of a vehicle, annual mileage, and age of the driver. In the following, these pieces of information will be referred to as “basic information”.

### (2) Image for Determining Presence/Absence of Upgrade Performed in Ex-Post Manner

For example, an image obtained by capturing a location where the sticker described above is attached. The collection unit 2011 determines whether the target vehicle is upgraded in an ex-post manner, based on such an image. In the following, this image will be referred to as “first image”.

Furthermore, in the case where it is determined that the target vehicle is upgraded in an ex-post manner, the collection unit 2011 makes an inquiry to the vehicle management server 300 and acquires the upgrade history. By referring to the upgrade history, the collection unit 2011 can grasp what kind of upgrade was performed in the past in relation to the target vehicle.

Information about details of an upgrade (such as information indicating which ability was added by the upgrade or indicating the degree of improvement in safety) will be referred to as “upgrade information” in the following.

The calculation unit 2012 calculates the insurance premium for the target vehicle based on the information collected by the collection unit 2011.

In the case where the target vehicle is not upgraded, the calculation unit 2012 calculates the insurance premium based on the basic information and the criteria data. In the case where the target vehicle is upgraded, the calculation unit 2012 calculates the insurance premium based on the basic data, the upgrade information, and the criteria data. More specifically, in the case where the ability related to the upgrade is for improving safety of the vehicle, a process for reducing the insurance premium according to the contents of the upgrade is performed.

The storage unit 202 includes a main memory and an auxiliary memory. The main memory is a memory where programs to be executed by the controller 201, and data to be used by the control programs are developed. The auxiliary memory is a device where the programs to be executed by the controller 201, and the data to be used by the control programs are stored.

Furthermore, the storage unit 202 stores criteria data 202A and user data 202B.

The criteria data 202A is recorded data of calculation criteria for the insurance premium. The calculation criteria for the insurance premium may include, for example, a vehicle name, a grade, a model year, an annual mileage, age of a driver, and presence/absence, type, performance and the like of abilities (or devices) related to safety. The criteria data 202A may be a database, a machine learning model or the like. The criteria data 202A is updated as appropriate based on a state of vehicle insurance market.

In the present embodiment, the criteria are set such that the insurance premium is reduced in a case where an ability (or a device) related to safety is included in the target vehicle than not. For example, the abilities (or devices) related to safety may include, for example, autonomous emergency braking, an unintended start prevention ability, an adaptive cruise control device, lane departure warning, a lane keeping support device, a rear side vehicle detection device and the like. Moreover, the criteria are set such that the insurance premium is further reduced, the higher the performance of the ability (or the device). For example, the amount of discount on the insurance premium is greater, the higher the vehicle performance related to safety (such as performance of detection of pedestrians and bicycles, size of a detection area, a range of detection targets, tolerance to bad weather, and the like).

The user data 202B is data about a vehicle (a target vehicle) that is a target of calculation of the insurance premium, and a driver of the target vehicle. The user data 202B includes the basic information, the first image, and the upgrade information described above.

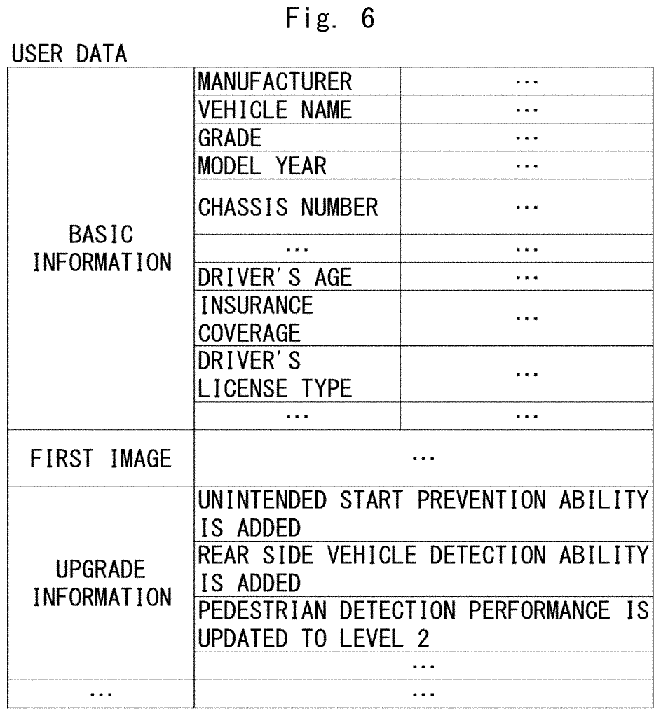

FIG. 6 is an example of the user data 202B. The user data 202B is updated when the collection unit 2011 receives the basic information and the first image from the user terminal 100. The user data 202B is also updated when the collection unit 2011 acquires the upgrade information.

The communication unit 203 is a communication interface for connecting the calculation server 200 to a network. For example, the communication unit 203 includes a network interface board, or a wireless communication interface for wireless communication.

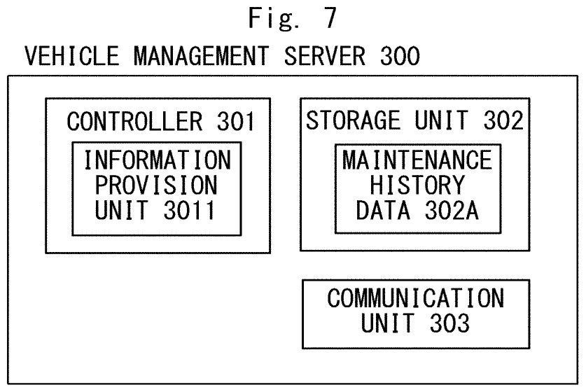

Next, the vehicle management server 300 will be described. FIG. 7 is a diagram illustrating in detail components of the vehicle management server 300 included in the insurance premium calculation system according to the present embodiment.

The vehicle management server 300 is a server apparatus that stores the history information about a plurality of vehicles, and that provides the history information to the calculation server 200. The vehicle management server 300 includes a database that stores, in relation to a given vehicle, the history information, namely, the history of repairs, the history of upgrades, and the history of replacement of consumables, and is capable of updating and providing the data as necessary.

Like the calculation server 200, the vehicle management server 300 may be a computer. That is, the vehicle management server 300 may be a computer that includes processors such as a CPU and a GPU, main memories such as a RAM and a ROM, and auxiliary memories such as an EPROM, a hard disk drive and a removable medium.

The vehicle management server 300 includes a controller 301, a storage unit 302, and a communication unit 303.

The controller 301 is an arithmetic device in charge of control that is performed by the vehicle management server 300. The controller 301 can be implemented by an arithmetic processing device such as a CPU.

As a functional module, the controller 301 includes an information provision unit 3011. This functional module may be implemented by execution of a stored program by the CPU.

The information provision unit 3011 provides the history information in response to a request from the calculation server 200. In the present embodiment, the information provision unit 3011 searches a database described later based on an identifier of a vehicle received from the calculation server 200, and provides the obtained history information to the calculation server 200.

The storage unit 302 includes a main memory and an auxiliary memory. The main memory is a memory where programs to be executed by the controller 301, and data to be used by the control programs are developed. The auxiliary memory is a device where the programs to be executed by the controller 301, and the data to be used by the control programs are stored.

The storage unit 302 further stores maintenance history data 302A.

The maintenance history data 302A is a database storing a history (a maintenance history) of maintenance work performed on each of a plurality of vehicles being managed. The maintenance history data 302A includes the following three types of data.

### (1) History of Repairs

A history of repairing or replacing a vehicle part or a vehicle component of a vehicle.

### (2) History of Replacement of Consumables

A history of replacing or replenishing consumables of a vehicle.

### (3) Upgrade History

A history of upgrading a vehicle part or a vehicle component of a vehicle (through addition, replacement, software update or the like, for example).

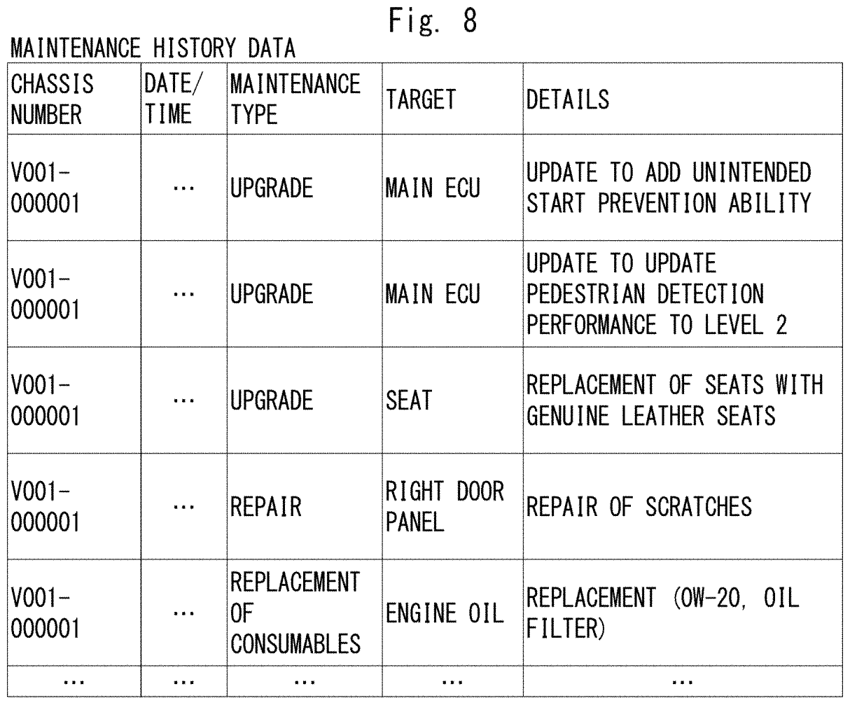

FIG. 8 illustrates an example of the maintenance history data 302A. In the present example, the maintenance history data 302A is a table including the fields of chassis number, date/time, maintenance type, target, and details.

Data indicating the chassis number of a target vehicle is stored in the chassis number field. Data indicating date/time when the work was performed is stored in the date/time field. Data indicating type (category) of maintenance work is stored in the maintenance type field. In the present example, there are three categories of “repair”, “replacement of consumables”, and “upgrade”.

Data specifying a vehicle part or a vehicle component of the target vehicle, as a work target, is stored in the target field. For example, in the case where a predetermined electronic control unit (ECU) is replaced or software thereof is updated, data specifying the ECU is stored in the target field. Furthermore, in the case where repair is performed, data specifying a vehicle part or a vehicle component (for example, a door panel) that is a repair target is stored in the target field. Moreover, in the case where replenishment/replacement of consumables is performed, data indicating the category of replenished/replaced consumables (for example, engine oil) is stored in the target field.

Data about details of maintenance work is stored in the details field. For example, in the case where contents of maintenance work are “upgrade”, data indicating the grade of a product that replaced the target vehicle part, the ability that is newly added, the degree of improvement in performance, or the like is stored in the details field. Furthermore, in the case where contents of maintenance work are “repair”, data indicating the type of repair work performed on the target vehicle part (or vehicle component) is stored in the details field. Furthermore, in the case where contents of maintenance work are “replacement of consumables”, data indicating the grade of consumables after replenishment/replacement, or the like is stored in the details field.

The communication unit 303 is a communication interface for connecting the vehicle management server 300 to a network. For example, the communication unit 303 includes a network interface board, or a wireless communication interface for wireless communication.

Additionally, configurations illustrated in FIGS. 4, 5, and 7 are merely examples, and one or some or all of the illustrated functions may be implemented using a dedicated designed circuit. Furthermore, programs may be stored and executed by a combination of a main memory and an auxiliary memory other than those illustrated.

Next, details of processes performed by the apparatuses included in the insurance premium calculation system will be given.

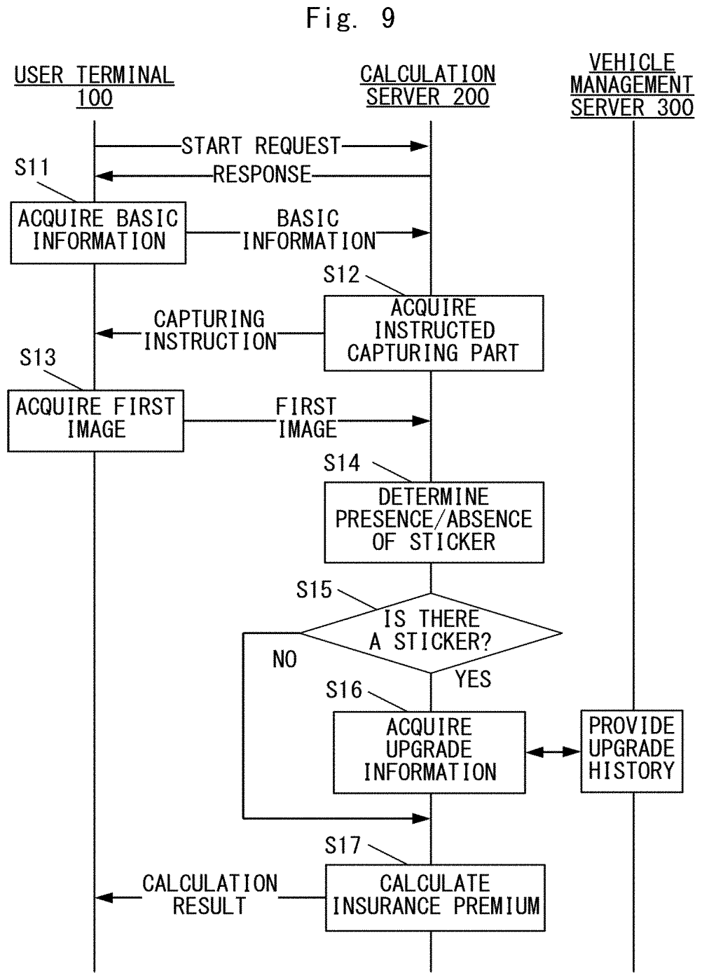

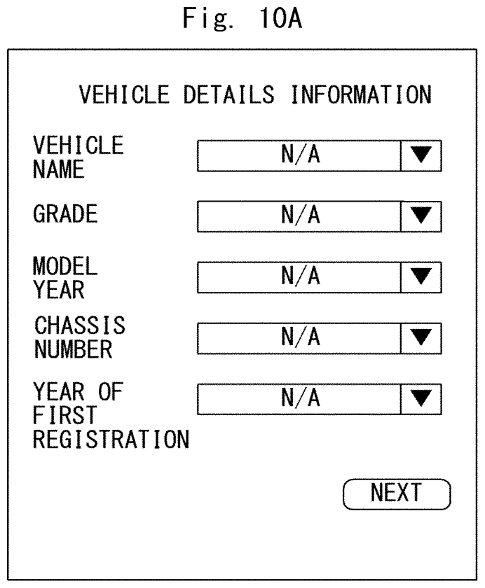

FIG. 9 is a sequence diagram illustrating processes that are performed by the user terminal 100, the calculation server 200, and the vehicle management server 300.

The illustrated processes are started when a request (a start request) to start calculation of the insurance premium is transmitted from the user terminal 100 to the calculation server 200.

When the calculation server 200 transmits a response to the user terminal 100, the user terminal 100 performs a step of acquiring the basic information (S11).

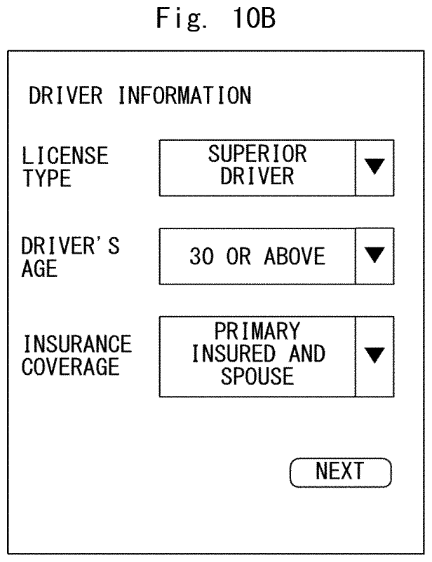

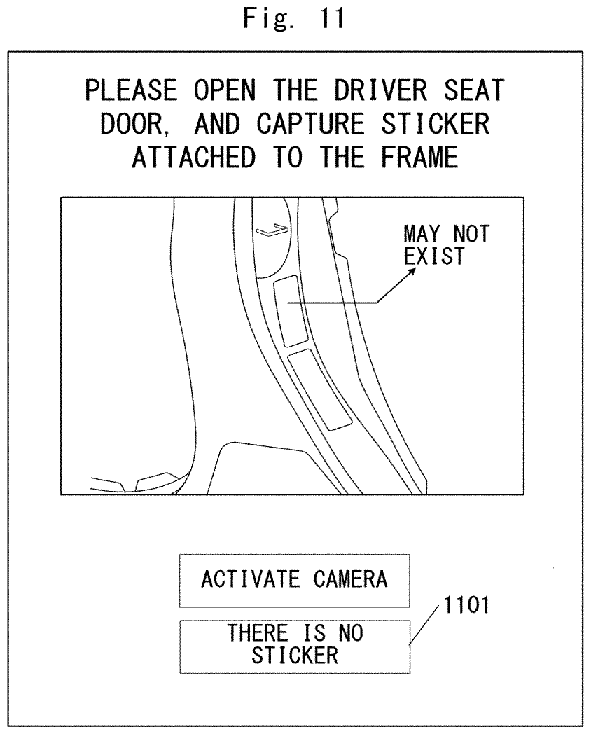

In step S11, the user terminal 100 receives input of the basic information. In the present step, the user terminal 100 makes the user input the basic information about the target vehicle and the driver using a predetermined user interface screen. FIG. 10A is an example of the user interface screen for inputting information about the target vehicle. FIG. 10B is an example of the user interface screen for inputting information about the driver.

Additionally, in the present step, in addition to the information mentioned, input about contents of an insurance contract may also be received. For example, information about a target of coverage, the amount of coverage, presence/absence of ancillary services, and the like may be input in the present step.

The basic information that is input is transmitted to the calculation server 200 (the collection unit 2011). The collection unit 2011 stores the basic information that is received, in the user data 202B.

In step S12, the calculation server 200 (the collection unit 2011) identifies, in relation to the target vehicle, the part where the sticker is attached, and creates data instructing to capture the part. The attachment part of the sticker may be stored in the storage unit 202 in advance. Additionally, in the case where the attachment part of the sticker is different depending on the vehicle, the collection unit 2011 may identify a vehicle model of the target vehicle based on the basic information, and may identify the attachment part based on the vehicle model. Data instructing to perform capturing may include a drawing or text, for example.

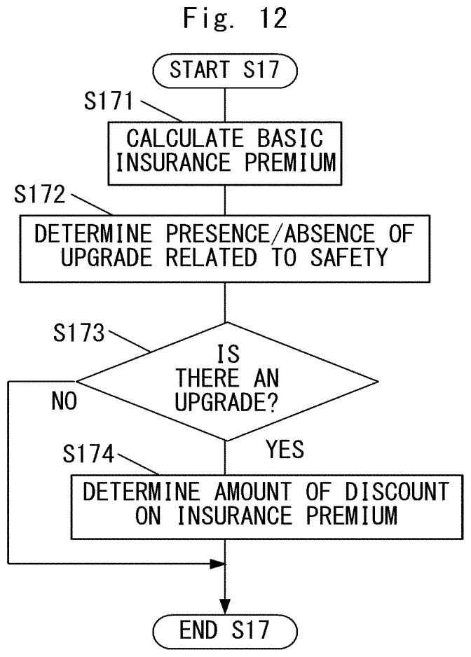

Data instructing to perform capturing is transmitted to the user terminal 100, and is output via a screen. FIG. 11 is an example of a screen instructing to perform capturing.

In step S13, the user terminal 100 acquires an image of the instructed part via the camera 105, and transmits the obtained image to the calculation server 200 as the first image. Additionally, in the case where a vehicle to which the sticker is not attached is the target vehicle, the first image may not include the sticker.

The collection unit 2011 stores the first image that is received, in the user data 202B.

In step S14, the collection unit 2011 determines whether the sticker is included in the first image. Detection of the sticker can be performed by a known technology such as pattern matching.

Here, in the case where the sticker is not detected from the first image (step S15: No), it is determined that the target vehicle is not upgraded. In this case, the process proceeds to step S17. In the case where the sticker is detected from the first image (step S15: Yes), it is determined that the target vehicle is upgraded. In this case, the process proceeds to step S16.

In step S16, the calculation server 200 makes an inquiry to the vehicle management server 300, and acquires the upgrade history of the target vehicle. In the present step, the calculation server 200 issues a request to search the maintenance history data 302A with the identifier (such as the chassis number) of the target vehicle as a key, and the vehicle management server 300 searches the maintenance history data 302A in response. Additionally, the search is performed by taking only records where the maintenance type is “upgrade” as targets. A record obtained as a result of the search is transmitted to the calculation server 200. The calculation server 200 (the collection unit 2011) creates the upgrade information based on the information, and stores the upgrade information in the user data 202B. The upgrade information includes information for identifying the contents of the upgrade performed on the vehicle in the past. For example, in the case where an upgrade was performed to improve preventive safety performance, the upgrade information includes detailed information about the preventive safety performance.

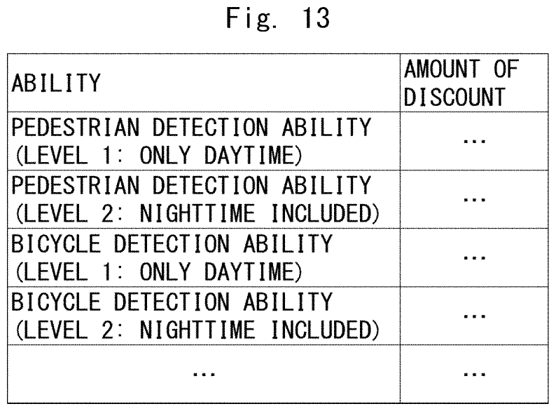

In step S17, the calculation unit 2012 calculates the insurance premium for the target vehicle based on the data stored in the user data 202B, that is, the basic information or both of the basic information and the upgrade information. FIG. 12 is a flowchart of processes that are performed by the calculation unit 2012 in step S17.

First, in step S171, an insurance premium as a base (a basic insurance premium) is calculated. The basic insurance premium is the insurance premium that does not take into account an upgrade that is performed in an ex-post manner. The basic insurance premium can be calculated by a known method based on the basic information and the criteria data 202A.

Next, in step S172, presence/absence of an upgrade related to safety is determined. In the present step, whether an ability of the target vehicle that is added or updated is related to safety is determined based on the upgrade information.

In the case where it is determined that an upgrade related to safety is performed (step S173: Yes), the process proceeds to step S174. In the case where it is determined that an upgrade related to safety is not performed (step S173: No), the process in step S17 is ended.

In step S174, the amount of discount on the insurance premium is determined based on the contents of the upgrade. The amount of discount on the insurance premium may be determined based on data associating an ability, of the vehicle, related to safety and the amount of discount.

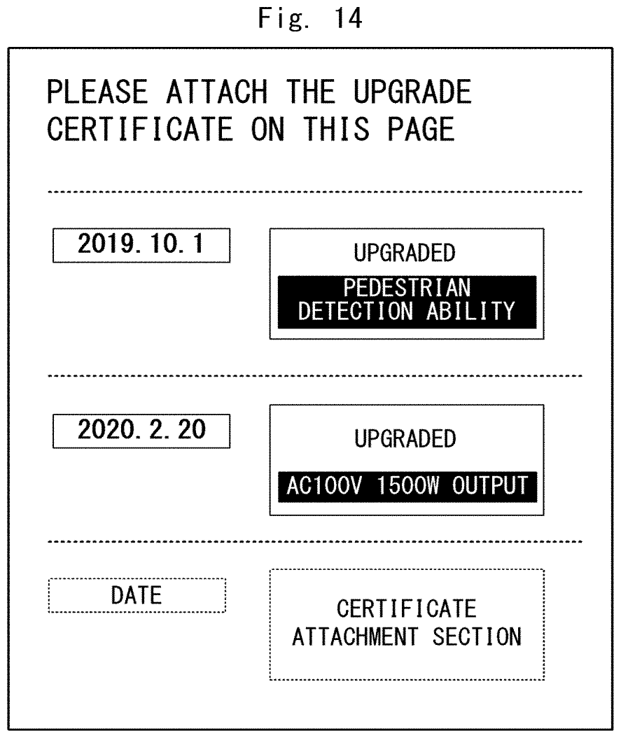

FIG. 13 is an example of the data associating an ability related to safety and the amount of discount. Any type of data may be used as long as the amount of discount may be determined based on the ability that is updated by the upgrade. Additionally, in the illustrated example, the amount of discount is set for presence/absence of each ability, but instead, specific performance and the amount of discount may be associated with each other.

Additionally, the amount of discount may be indicated in the amount of money or in a discount rate (percentage). Such data may be stored in the criteria data 202A.

The insurance premium that is obtained as a result of calculation is transmitted to the user terminal 100, and is presented to the user.

As described above, in the first embodiment, a user requesting calculation of an insurance premium captures the image of the sticker attached to the target vehicle with the user terminal 100, and transmits the image to the calculation server 200. Furthermore, the calculation server 200 acquires information about details of an upgrade performed on the target vehicle, by using the image. According to such a configuration, even when a user does not know about vehicles, the calculation server 200 may grasp whether an upgrade related to safety is performed or not.

Additionally, in the present embodiment, whether the sticker is attached or not is determined by the calculation server 200 based on the first image, but instead, whether the sticker is attached or not may be input by the user.

For example, a user may declare whether the sticker is attached or not, by pressing a button as indicated by a reference sign 1101 in FIG. 11. In this case, the user terminal 100 transmits, to the calculation server 200, data indicating whether the sticker is attached or not, instead of the first image.

### Second Embodiment

In the first embodiment, the calculation server 200 acquires the upgrade information by making an inquiry to the vehicle management server 300. In contrast, a second embodiment is an embodiment in which the calculation server 200 instructs the user to collect the upgrade information.

Additionally, the insurance premium calculation system according to the second embodiment does not include the vehicle management server 300 described in the first embodiment.

As described above, the sticker that is attached to a vehicle body displays that the vehicle is upgraded in some way in an ex-post manner.

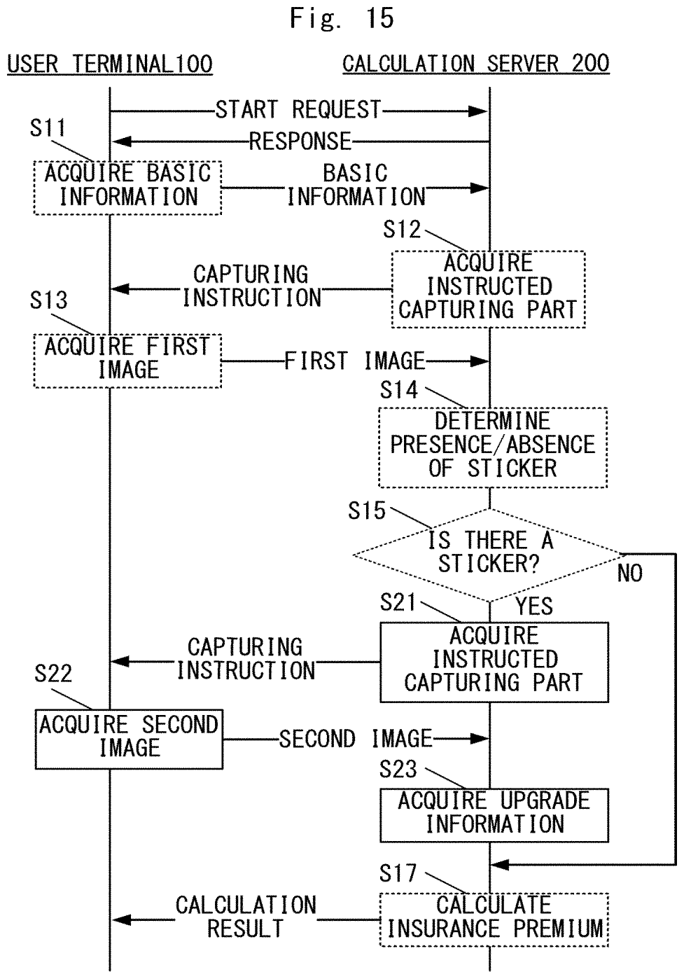

Detailed information about an upgrade is possibly recorded in a maintenance note (a maintenance record) of the vehicle. For example, it is conceivable to issue a certificate (hereinafter “upgrade certificate”) describing contents of an upgrade every time an upgrade is performed, and to attach the certificate in the maintenance note or the like. FIG. 14 is an example of the maintenance note where the upgrade certificate is attached. As illustrated, one upgrade certificate is issued every time an upgrade is performed.

In the second embodiment, in the case where the sticker is detected from the first image, the calculation server 200 instructs the user to capture the upgrade certificate. For example, the calculation server 200 instructs the user to open a predetermined page of the maintenance note and to capture the upgrade certificate. The image that is obtained by capturing the upgrade certificate will be referred to as a second image.

Furthermore, the calculation server 200 creates the upgrade information based on the upgrade certificate detected from the second image that is obtained.

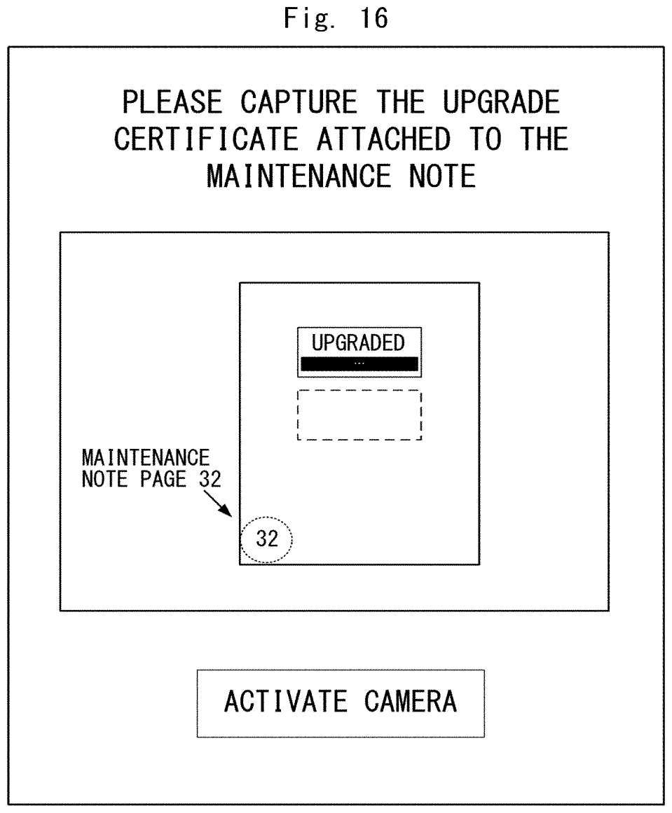

FIG. 15 is a sequence diagram illustrating processes that are performed by the user terminal 100 and the calculation server 200 in the second embodiment. Processes in steps S11 to S15 are the same as those in the first embodiment, and detailed description thereof is omitted. Here, a process that is performed in a case where a positive determination is made in step S15 (a case where it is determined that the sticker is included in the first image) will be described.

First, in step S21, the collection unit 2011 identifies the part where the upgrade certificate is attached, and creates data instructing to capture the part. The attachment part of the upgrade certificate may be a predetermined page of the maintenance note (the maintenance record) of the vehicle, for example. Data about the attachment part (such as a page number) of the upgrade certificate may be stored in the storage unit 202. Additionally, in the case where the attachment part of the upgrade certificate is different depending on the vehicle, the collection unit 2011 may identify the vehicle model based on the basic information, and may identify the attachment part based on the vehicle model.

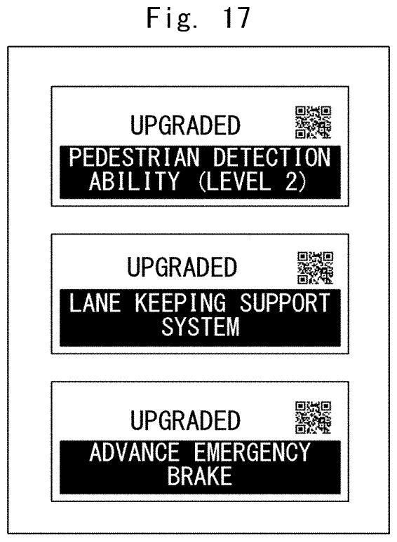

Data instructing to perform capturing is transmitted to the user terminal 100, and is output via a screen. FIG. 16 is an example of a screen instructing to perform capturing.

In step S22, the user terminal 100 acquires an image of the instructed part via the camera 105, and transmits the obtained image to the calculation server 200 as the second image. The collection unit 2011 stores the second image that is received, in the user data 202B.

Additionally, in the present example, an example is cited where a plurality of upgrade certificates is attached on a specific page of the maintenance note, but the upgrade certificates may instead be attached separately on a plurality of pages. Moreover, the upgrade certificate does not necessarily have to be attached.

In this case, the user terminal 100 may transmit a plurality of images obtained by capturing the plurality of upgrade certificates to the calculation server 200 as the second images.

In step S23, the collection unit 2011 detects one or more upgrade certificates from the second image, and identifies contents of the upgrade corresponding to each certificate. Contents of an upgrade may be identified by recognizing text described on the upgrade certificate, for example. Additionally, a code for identifying contents of an upgrade may be printed on the upgrade certificate. For example, a character string indicating information about contents of an upgrade may be two-dimensionally coded and be printed on the upgrade certificate. In this case, the collection unit 2011 can identify the contents of the upgrade by decoding the two-dimensional code.

The collection unit 2011 creates the upgrade information based on the contents that are identified, and stores the upgrade information in the user data 202B.

A process performed in step S17 is the same as that in the first embodiment.

As described above, in the second embodiment, in the case where the sticker attached to a vehicle body is detected, the calculation server 200 creates an instruction for the user to capture the upgrade certificate, and acquires the second image including the upgrade certificate. According to such a mode, the user may provide information about an upgrade to the calculation server 200 simply by performing capturing according to the instruction.

### Third Embodiment

In the second embodiment, there is only one type of sticker that is attached to the vehicle, but a plurality of stickers describing specific contents of upgrades may be attached to the vehicle. That is, the upgrade certificates according to the second embodiment may be attached to the vehicle body.

In a third embodiment, in the case where a vehicle is upgraded several times, a plurality of stickers is attached to the vehicle. A character string, a code or the like for identifying contents of the upgrade may be described on each sticker. FIG. 17 is an example of the sticker according to the third embodiment. Such stickers may be attached next to each other at a predetermined part (such as the center pillar) of the vehicle body.

In the third embodiment, an image that is obtained by capturing such stickers is taken as the first image.

Furthermore, in the third embodiment, the calculation server 200 acquires the upgrade information by performing the above-described process in step S23 on the first image. That is, the processes in steps S14 to S22 in FIG. 15 can be omitted. In the third embodiment, capturing and transmission of the second image are not performed.

A sticker describing contents of an upgrade may be attached as described above every time a vehicle is upgraded, and image recognition may be performed on the image obtained by capturing the sticker. Also, according to such a mode, the calculation server 200 can grasp presence/absence of an upgrade and contents thereof.

Additionally, in the third embodiment, acquisition of the second image is not necessary, but it is also possible to request the user terminal 100 to transmit the second image. It is possible to include both the sticker and the upgrade certificate captured so that that the vehicle is upgraded may be reliably proven. In this case, a discount process for the insurance premium may be performed in the case where a description on the sticker and a description on the upgrade certificate match each other.

### (Modifications)

The embodiments described above are merely examples, and the present disclosure may be changed as appropriate within the scope of the disclosure.

For example, the processes and means described in the present disclosure may be freely combined to the extent that no technical conflict exists.

Moreover, in the second embodiment, that an upgrade certificate is for the target vehicle cannot be proven. Accordingly, information for performing association with the vehicle may be included in the second image.

For example, in the case where the chassis number or a serial number is printed on the upgrade certificate (or the maintenance record), a second image including both the upgrade certificate and the chassis number (the serial number) may be acquired. In this case, that the upgrade certificate is for the target vehicle can be checked when the calculation server 200 reads the chassis number (or the serial number) included in the second image.

The same can be said for the third embodiment. For example, in the case where the sticker in the third embodiment is attached near the caution plate, a first image including both the sticker and the caution plate may be acquired. In this case, that the sticker included in the first image is attached to the target vehicle can be checked when the calculation server 200 reads the chassis number on the caution plate.

Furthermore, a process that is described to be performed by one apparatus may be shared and performed by a plurality of apparatuses. Processes described to be performed by different apparatuses may be performed by one apparatus. Which function is to be implemented by which hardware configuration (server configuration) in a computer system may be flexibly changed.

The present disclosure may also be implemented by supplying computer programs for implementing the functions described in the embodiments described above to a computer, and by one or more processors of the computer reading out and executing the programs. Such computer programs may be provided to the computer by a non-transitory computer-readable storage medium that can be connected to a system bus of the computer, or may be provided to the computer through a network. The non-transitory computer-readable storage medium may be any type of disk including magnetic disks (floppy (registered trademark) disks, hard disk drives (HDDs), etc.) and optical disks (CD-ROMs, DVD discs, Blu-ray discs, etc.), read-only memories (ROMs), random access memories (RAMS), EPROMs, EEPROMs, magnetic cards, flash memories, optical cards, and any type of medium suitable for storing electronic instructions.

What is claimed is:

1. An information processing apparatus comprising a controller including at least one processor configured to:
determine whether a sticker displaying that an upgrade is performed on an ability of a vehicle in an ex-post manner is attached to a first vehicle,
identify contents of the upgrade in a case where the sticker is attached to the first vehicle, and
calculate an insurance premium for the first vehicle by taking into account the contents of the upgrade, in a case where the ability that is upgraded is related to safety.

2. The information processing apparatus according to claim 1, wherein the controller detects the sticker from a first image transmitted from a user terminal.

3. The information processing apparatus according to claim 2, wherein the controller transmits, to the user terminal, data instructing that a predetermined location where the sticker is attached be captured.

4. The information processing apparatus according to claim 3, wherein the data includes data notifying of the predetermined location.

5. The information processing apparatus according to claim 2, wherein the controller identifies the contents of the upgrade based on a description on the sticker included in the first image.

6. The information processing apparatus according to claim 5, wherein the controller identifies the contents of the upgrade by decoding a code on the sticker included in the first image.

7. The information processing apparatus according to claim 2, wherein, in a case where the sticker is attached to the first vehicle, the controller identifies the contents of the upgrade by making an inquiry to a server apparatus storing an upgrade history of the first vehicle.

8. The information processing apparatus according to claim 2, wherein, the controller requests the user terminal for transmission of a second image, and identifies the contents of the upgrade based on the second image.

9. The information processing apparatus according to claim 8, wherein the second image is an image obtained by capturing a certificate about the upgrade.

10. The information processing apparatus according to claim 9, wherein the second image is an image including both the certificate and a chassis number of the first vehicle.

11. An information processing method comprising:
determining whether a sticker displaying that an upgrade is performed on an ability of a vehicle in an ex-post manner is attached to a first vehicle;
identifying contents of the upgrade in a case where the sticker is attached to the first vehicle; and
calculating an insurance premium for the first vehicle by taking into account the contents of the upgrade, in a case where the ability that is upgraded is related to safety.

12. The information processing method according to claim 11, further comprising detecting the sticker from a first image transmitted from a user terminal.

13. The information processing method according to claim 12, further comprising transmitting, to the user terminal, data instructing that a predetermined location where the sticker is attached be captured.

14. The information processing method according to claim 13, wherein the data includes data notifying of the predetermined location.

15. The information processing method according to claim 12, further comprising identifying the contents of the upgrade based on a description on the sticker included in the first image.

16. The information processing method according to claim 12, wherein, in a case where the sticker is attached to the first vehicle, the contents of the upgrade are identified by making an inquiry to a server apparatus storing an upgrade history of the first vehicle.

17. The information processing method according to claim 12, further comprising requesting the user terminal for transmission of a second image, and identifying the contents of the upgrade based on the second image.

18. The information processing method according to claim 17, wherein the second image is an image obtained by capturing a certificate about the upgrade.

19. The information processing method according to claim 18, wherein the second image is an image including both the certificate and a chassis number of the first vehicle.

20. A non-transitory storage medium storing a program for causing a computer to perform the information processing method according to claim 11.
